(19) United States
(12) Patent Application Publication
(10) Pub. No.: US 2025/0174369 A1
(43) Pub. Date: May 29, 2025

(54) MOLTEN SALT REACTOR WITH HORIZONTALLY ACTUATED CONTROL BLADE

(71) Applicant: Natura Resources LLC, Abilene, TX (US)

(72) Inventor: Kevin T. Clarno, Austin, TX (US)

(21) Appl. No.: 18/522,447

(22) Filed: Nov. 29, 2023

(51) Int. Cl. G21C 7/14; G21C 7/24

(52) U.S. Cl. CPC G21C 7/14; G21C 7/24

(57) ABSTRACT

A molten salt nuclear reactor includes a vessel and a control blade assembly disposed within the vessel. The control blade assembly includes a drive rod and a control blade. The drive rod further includes an oblique surface wherein vertical motion of the drive rod and its oblique surface causes horizontal motion of the control blade into and out of a reactor section of the molten salt reactor.

### TECHNICAL FIELD

The described examples relate generally to systems, devices, and techniques for a molten salt reactor with one or more control blades that move horizontally.

### BACKGROUND

Molten salt reactors (MSRs) offer an approach to nuclear power that can utilize molten salts as their nuclear fuel in place of the conventional solid fuels used in light water reactors. Advantages include efficient fuel utilization and enhanced safety (largely due to replacing water as a coolant with molten salt). In some MSRs, fission reactions can occur within a molten salt composition housed within a reactor vessel. In certain conventional MSRs, fuel salt undergoes a fission reaction in a reactor vessel. Such conventional MSRs may operate by pumping the fuel salt from the reactor vessel along a “loop,” first to a primary heat exchanger, and then back to the reactor vessel so that the fuel salt may re-enter the reactor vessel for subsequent fission reactions (referred to as non-integral MSRs). In such a non-integral MSR, the reactor vessel, pump(s), heat exchanger(s) and/or other components may be fluidly coupled to one another in a loop by a series of pipes, flanges, and other connections. Alternatively, in some conventional systems, the functional components of the MSR may be arranged fully within an integral enclosure in order to form an integral or “pool-type” reactor whereby the fuel salt circulates between a reactor core and heat exchangers within a common vessel.

Among other systems, both non-integral MSRs and integral MSRs require a control system with control rods that are used to modulate the fission reactions in the molten fuel salt composition. The control rods comprise a material that absorbs neutrons emitted by the fission reactions, thereby controlling the fission reaction. In conventional systems, control rods comprise long vertical rods that can be lowered into and raised out of the reactor core of the reactor in order to modulate the fission reaction. However, such an arrangement requires a substantial amount of open space above the reactor vessel, referred to as head space, to provide clearance for raising and lowering the control rods. The substantial head space could be better used if it was available for other equipment such as cooling systems, chemistry control systems, and fuel management systems. Accordingly, there is a need for an improved control system that arranges control rods without consuming substantial head space above the reactor vessel so that such head space is free for use by other systems of the reactor.

### SUMMARY

In one example, a molten salt nuclear reactor is disclosed. The molten salt nuclear reactor includes a reactor section disposed within a vessel, wherein the reactor section is configured to receive a volume of fuel salt and heat the fuel salt through fission reactions. The molten salt nuclear reactor also includes a heat exchange section configured to receive a flow of the fuel salt from the reactor section after heating and to remove heat therefrom. Furthermore, the molten salt nuclear reactor includes a control blade assembly disposed within the vessel, wherein the control blade assembly includes a control blade joined by a coupling to a drive rod, wherein motion of the drive rod causes the control blade to move horizontally within the vessel.

As another example, in one or more of the examples described herein, the drive rod of the control blade assembly may be configured to move vertically within the vessel.

As another example, in one or more of the examples described herein, the control blade may move into the reactor section in response to the drive blade moving downward in the vessel.

As another example, in one or more of the examples described herein, the control blade may move away from the reactor section in response to the drive blade moving upward in the vessel.

As another example, in one or more of the examples described herein, an inward surface of the drive rod may be oblique to a vertical axis of the vessel and may be coupled to the control blade, wherein vertical movement of the inward surface of the drive rod causes horizontal movement of the control blade.

As another example, in one or more of the examples described herein, the control blade may comprise boron carbide.

As another example, in one or more of the examples described herein, the control blade may comprise boron carbide and the boron carbide may be enclosed in a stainless steel cladding.

As another example, in one or more of the examples described herein, the control blade assembly may further comprise a container arranged to surround at least a portion of the control blade.

As another example, in one or more of the examples described herein, the molten salt nuclear reactor may be an integral molten salt nuclear reactor, and the container may be welded to an inner wall of the vessel.

As another example, in one or more of the examples described herein, the container may comprise: a top aperture through which the drive rod moves vertically, and a side aperture through which the control blade moves horizontally.

As another example, in one or more of the examples described herein, the coupling may allow the drive rod to slide vertically relative to the control blade.

As another example, in one or more of the examples described herein, the coupling may comprise a slider that slides within a slot.

As another example, in one or more of the examples described herein, the coupling may comprise a linkage connecting the drive rod and the control blade.

As another example, in one or more of the examples described herein, a barrel may be disposed in the vessel between the reactor section and the vessel.

As another example, in one or more of the examples described herein, the control blade may move horizontally through the barrel.

As another example, in one or more of the examples described herein, the molten salt nuclear reactor is an integral molten salt nuclear reactor and the control blade assembly further comprises a container that surrounds a portion of the control blade, wherein the container is welded to an inner wall of the vessel.

As another example, in one or more of the examples described herein, the container may comprise: a top aperture through which the drive rod moves vertically, and a side aperture through which the control blade moves horizontally.

In another example, a method of operating a molten salt nuclear reactor is disclosed. The method includes circulating a fuel salt from a reactor section to a heat exchange section of the molten salt nuclear reactor, wherein the circulating includes removing heat from the fuel salt. The method further includes activating a control blade assembly disposed within a vessel of the molten salt nuclear reactor, the control blade assembly including a control blade joined by a coupling to a drive rod, wherein the activating includes moving the drive rod in a vertical direction causing the control blade to move in a horizontal direction.

As another example, in one or more of the examples described herein, the method may further include moving the drive rod in a downward direction within the vessel causing the control blade to move in a horizontal direction into the reactor core.

As another example, in one or more of the examples described herein, the method may further include moving the drive rod in an upward direction within the vessel causing the control blade to move in a horizontal direction out of the reactor core.

The foregoing embodiments are non-limiting examples and other aspects and embodiments will be described herein. The foregoing summary is provided to introduce various concepts in a simplified form that are further described below in the detailed description. Further aspects and examples will become apparent by reference to the drawings and by study of the following description. This summary is not intended to identify required or essential features of the claimed subject matter nor is the summary intended to limit the scope of the claimed subject matter.

### BRIEF DESCRIPTION OF THE DRAWINGS

FIG. 1 depicts a schematic representation of an example integral molten salt nuclear reactor in a first configuration.

FIG. 2 depicts a schematic representation of the integral molten salt nuclear reactor of FIG. 1 in a second configuration.

FIG. 3 depicts a schematic representation of the integral molten salt nuclear reactor of FIG. 1 in a third configuration.

FIG. 4 depicts an integral molten salt nuclear reactor comprising a control system with control rods as known in the prior art.

FIG. 5 depicts a reactor section of the integral molten salt nuclear reactor of FIG. 4A.

FIG. 6 depicts an integral molten salt nuclear reactor comprising a control blade assembly in accordance with the example embodiments of the present disclosure.

FIG. 7 depicts an example of a control blade assembly in accordance with the example embodiments of the present disclosure.

FIG. 8 depicts another example of a control blade assembly in accordance with the example embodiments of the present disclosure.

FIG. 9 depicts yet another example of a control blade assembly in accordance with the example embodiments of the present disclosure.

FIG. 10 depicts a flow diagram of a method of operating an integral molten salt nuclear reactor.

The use of cross-hatching or shading in the accompanying figures is generally provided to clarify the boundaries between adjacent elements and also to facilitate legibility of the figures. Accordingly, neither the presence nor the absence of cross-hatching or shading conveys or indicates any preference or requirement for particular materials, material properties, element proportions, element dimensions, commonalities of similarly illustrated elements, or any other characteristic, attribute, or property for any element illustrated in the accompanying figures.

Additionally, it should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

The description that follows includes sample systems, methods, and apparatuses that embody various elements of the present disclosure. However, it should be understood that the described disclosure may be practiced in a variety of forms in addition to those described herein.

As identified above, an improved approach to a control system and an arrangement of control rods for a molten salt nuclear reactor would be beneficial. The example embodiments described herein are directed to a control system and control blade assembly that provide one or more benefits as compared to conventional control systems and control blades. In particular, the control blade assemblies disclosed herein include a component that moves in the vertical direction and a component that moves in the horizontal direction. As such, the control blade assemblies described herein reduce the head space required for the control system, thereby freeing up the head space for other systems of the MSR, such as cooling systems, chemistry control systems, and fuel management systems. Another benefit of the control blade assemblies disclosed herein is that they facilitate a greater range of motion for the control blade, thereby allowing movement of the control blade farther away from the reactor core when it is desired to increase the reactivity of the reactor. The ability to move the control blade farther away from the core reactor can improve the reactor's efficiency.

The following disclosure provides example embodiments of control blade assemblies implemented in integral or “pool-type” molten salt nuclear reactors (MSRs). An “integral” MSR may generally refer to a MSR in which the components of the reactor functionally associated with the reactor may be disposed inside a common enclosure with the reactor core. In other words, integral MSRs may house a reactor core and one or more heat exchangers in a common vessel, and cause a fuel salt to circulate within the common vessel between the reactor core (at which the fuel salt may undergo a fission reaction that heats the salt) and a heat exchanger (at which the heat is removed from the fuel salt).

In contrast, non-integral MSR systems (or loop MSRs), may operate by pumping the fuel salt from the reactor vessel along a “loop,” first to a primary heat exchanger, and then back to the reactor vessel so that the fuel salt may re-enter the reactor vessel for subsequent fission reactions. The reactor vessel, pump(s), heat exchanger(s) and/or other components may be fluidly coupled to one another by a series of pipes, flanges, and other connections. While the example control blade assemblies described herein are provided in the context of an integral MSR, the example embodiments also can be implemented in non-integral MSRs. Additionally, the example control blade assemblies can be implemented in other types of nuclear reactors that are not molten salt reactors, such as graphite-moderated gas reactors and space reactors.

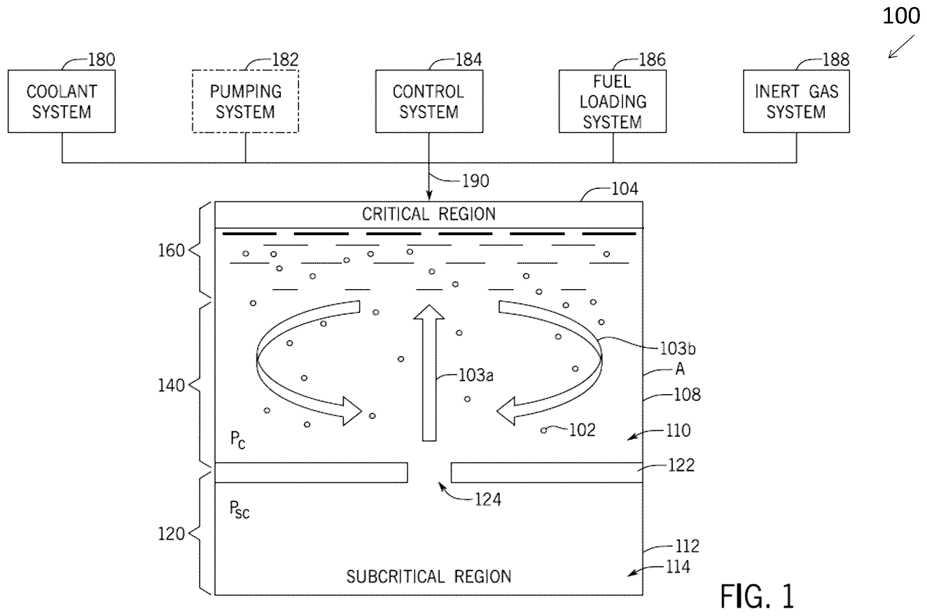

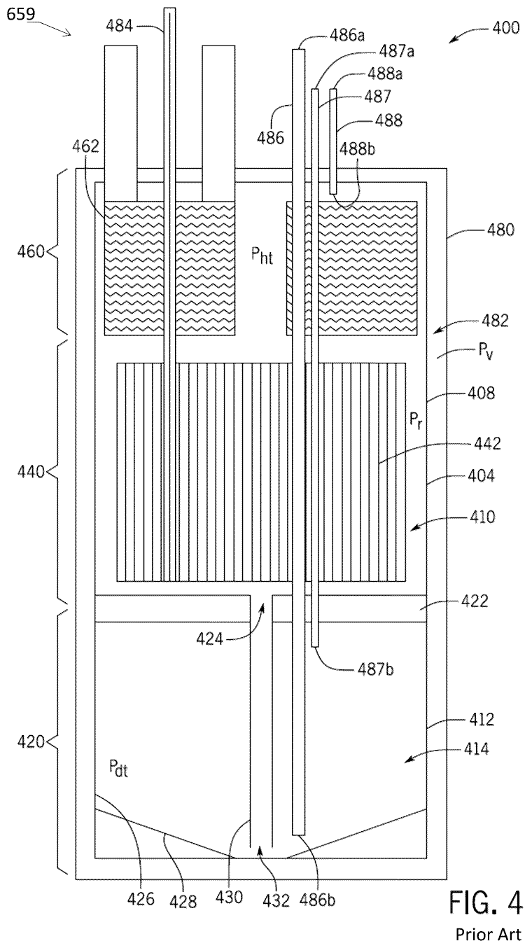

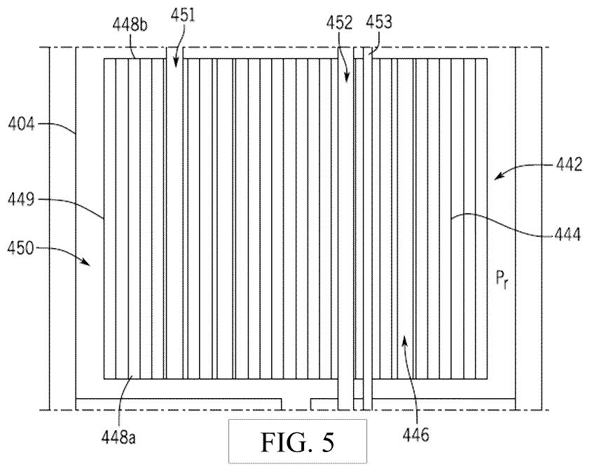

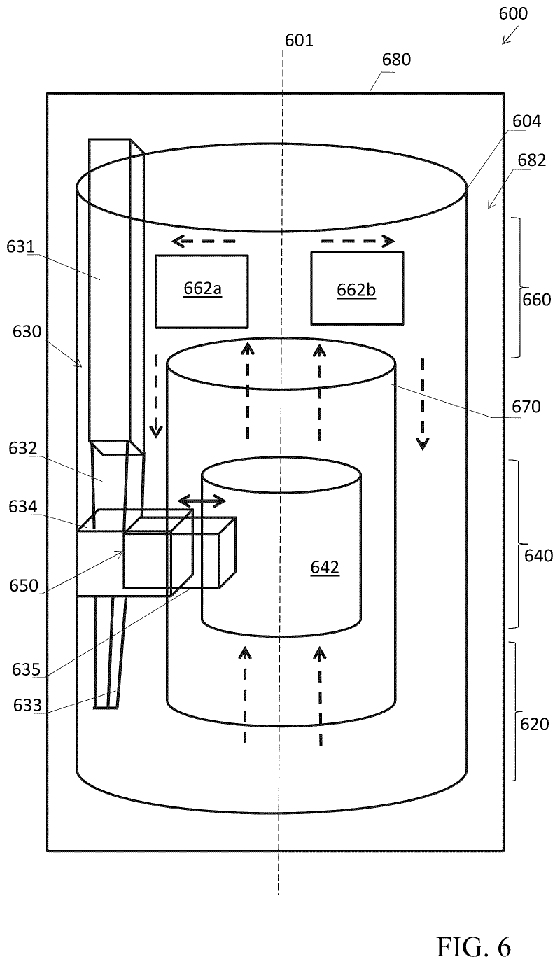

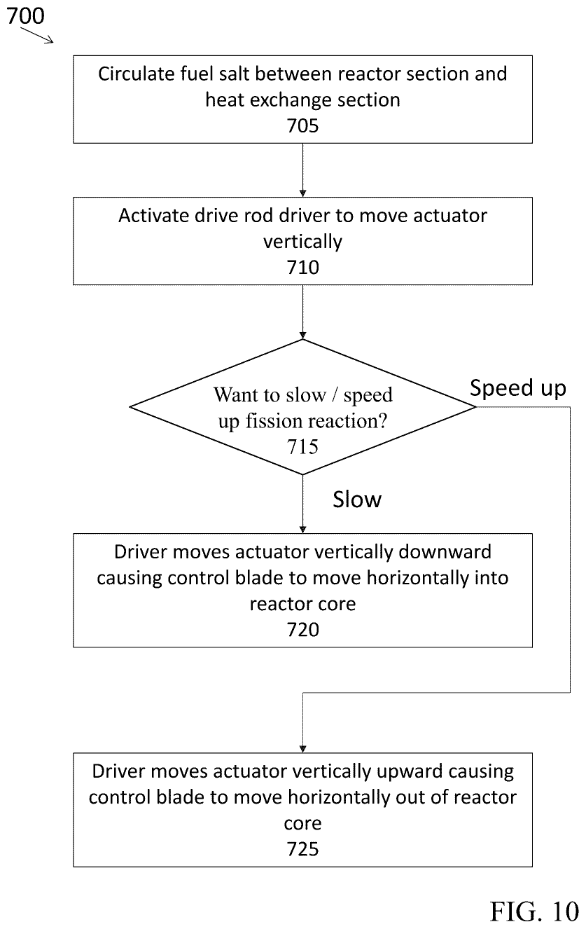

Referring now to the accompanying figures, FIGS. 1-3 are provided as context and illustrate non-limiting examples of the general arrangement and operation of an integral MSR. FIGS. 4 and 5 depict an integral MSR with a control blade assembly as is known in the prior art. FIGS. 6-9 illustrate example embodiments of the improved control blade assemblies of the current disclosure and FIG. 10 illustrates a method of operating a MSR with a control system and control blade assembly in accordance with the example embodiments disclosed herein.

Turning to FIG. 1, a schematic representation of an example integral MSR 100 is depicted. The integral MSR 100 is shown in a first configuration A in which a fuel salt 102 is circulated in a critical region 108 of the integral MSR 100 for generation and removal of heat caused by fission reactions. The integral MSR 100 is shown schematically as including a common, integrally constructed vessel 104. The vessel 104 may define both the critical region 108 and a subcritical region 112. The critical region 108 may define a critical volume 110 for the circulation of the fuel salt 102 and for the housing of fission reactions occurring therein. Further, the subcritical region 112 may define a subcritical volume 114 for the storage of the fuel salt 102 away from a reactor core or otherwise away from the critical region 104. As generally shown in FIG. 1, the critical region 108 may circulate the fuel salt 102 along a circulation flow path therein including a flow 103a through a reactor section 140 where the fuel salt 102 may generally be heated due to fission reactions occurring therein. As further shown in FIG. 1, the critical region 108 may circulate the fuel salt 102 along a circulation path therein including a flow 103b through a heat exchange section 160 and back to the reactor section 140 for recirculation via the flow 103a. At the heat exchange section 160, heat may be removed from the fuel salt 102 in order to circulate a cooler fuel salt 102 back to the reactor section 140 so that the fuel salt 102 may again be heated along the flow 103a. The circulation of the fuel salt 102 along the flows 103a, 103b may proceed continuously in order to provide a generally constant, steady stream of heat from the fission reactions to the heat exchangers of the system 100.

The integrally constructed vessel 104 is shown in FIG. 1 as including the subcritical region 112 therein, which may establish a drain tank section 120 of the integral MSR 100. Accordingly, the integral MSR 100 may be operable to maintain the fuel salt 102 in both a critical state, and a subcritical state, within the same, integrally constructed vessel 104. The subcritical volume 114 of the subcritical region 112 is shown separated from the critical volume 110 by an internal barrier 122. The internal barrier 122 may further define a fuel salt passage 124 therethrough in order to establish a flow path for the fuel salt 102 between the critical volume 110 and the subcritical volume 114.

The fuel salt 102 may be selectively held within the critical volume 110 and/or the subcritical volume 114 based on the maintenance of an inert gas pressure within each volume. For example, the critical volume 110 may be held at a pressure P_{c} and the subcritical volume may be held at a pressure P_{sc}. In the example of FIG. 1, in which the fuel salt 102 is circulated in the critical region 108, the integral MSR 100 may operate to maintain the pressure P_{sc} at a value that is greater than the pressure P_{c}. Accordingly, the fuel salt passage 124 may be pressurized to mitigate or prevent the introduction of fuel salt 102 into the subcritical volume 114 during the first configuration A, shown in FIG. 1. As described herein, the pressures P_{c}, P_{sc} may be manipulated in various manners in order to control the disposition of the fuel salt 102 as between the critical region 108 and the subcritical region 112.

The integral MSR 100 is also shown in FIG. 1 with various associated operational systems, including, but not limited to, a coolant system 180, an optional pumping system 182, a control system 184, a fuel loading system 186, and an inert gas system 188. Each such operational system may be broadly used to control or support one or more functions of the integral MSR 100 that occur in the vessel 104. Accordingly, the schematic diagram of FIG. 1 shows such operational systems as being coupled to the vessel 104 via an operative connection 190. The operative connection 190 may be indicative of any of a variety of mechanical, electrical, and fluidic control and coupling devices (including assemblies and subassemblies thereof), further examples of which are described in greater detail with reference to FIGS. 4-10 herein.

With reference to the coolant system 180, the coolant system 180 may operate to facilitate the removal of heat from the fuel salt 102 that is circulated through the critical region 108. The coolant system 180 may further operate to facilitate the transfer of such heat to further uses, such as transferring the heat for use in an electricity generation process, a chemical process, and/or any other operation in which heat may be used. For example, the coolant system 180 may include one or more coolant salt loops that circulate a coolant salt between the heat exchange section 160 of the critical region 108 and a secondary heat exchanger of the coolant system 180. The coolant salt receives the heat from the fuel salt 102 and allows such heat to be removed by a secondary coolant at the secondary heat exchanger for transfer of heat to another process.

With reference to the pumping system 182, the pumping system 182 may operate to cause the fuel salt 102 to circulate along the flows of 103a, 103b. For example, the pumping system 182 may include a pump (including a magnetic drive pump) having an impeller at least partially immersed in the fuel salt 102 in order to drive the flow of the fuel salt 102 by operation of the impeller. The pumping system 182 is depicted in phantom line in FIG. 1 and may be an optional component of the integral MSR 100. For example, in some cases, the pumping system 182 may be entirely omitted from the integral MSR 100. In such cases, the integral MSR 100 may be configured to cause the fuel salt 102 to circulate via the flows 103a, 103b via a convective process. For example, as the fuel salt 102 is heated at the reactor section 140, the fuel salt 102 may generally be permitted to rise and follow the flow path 103a. In turn, as heat is removed from the fuel salt 102 at the heat exchange section 160, the fuel salt 102 may generally be permitted to sink and follow the flow path 103b. In some cases, a combination of active pumping and a convective process may be used to facilitate the flows 103a, 103b.

With reference to the control system 184, the control system 184 may include any appropriate components to facilitate reactivity control. The control system 184 includes one or more control rods or control blades that may be selectively insertable into the critical region 108 of the vessel 104 in order to slow down, or stop, a nuclear reaction occurring therein. As described further below, FIGS. 4 and 5 illustrate conventional control rods that are moved entirely in the vertical direction and, thus, require substantial head space above the reactor vessel. In contrast, the embodiments of the present disclosure illustrated in FIGS. 6-9 implement control blades that move in the horizontal direction. In addition to control blades, reactivity may be controlled via coolant flow rates and fuel salt level adjustments.

With reference to the fuel loading system 186, the fuel loading system 186 may operate to load the fuel salt 102 into the vessel 104. As described in greater detail herein, such fuel loading system 186 may permit the fuel salt 102 to be first loaded into the subcritical region 112. Then, in response to an operation event, the fuel salt 102 may be transferred to the critical region 108, for example, by control of the pressures P_{c}, P_{sc}. With reference to the inert gas system 188, the inert gas system 188 may operate to control such pressures P_{c}, P_{sc}. For example, and as described in greater detail herein, the inert gas system 188 may be operatively coupled to a supply of inert gas, such as a helium gas. The inert gas system 188 may be further operated to supply such inert gas, selectively, to each of the critical volume 110 and the subcritical volume 114. As such, the inert gas system 188 may be used to control the pressures P_{c}, P_{sc}, which, as described herein, may be used to cause the fuel salt to be disposed in one of the critical region 108 or the subcritical region 112 based on an operational state of the integral MSR 100.

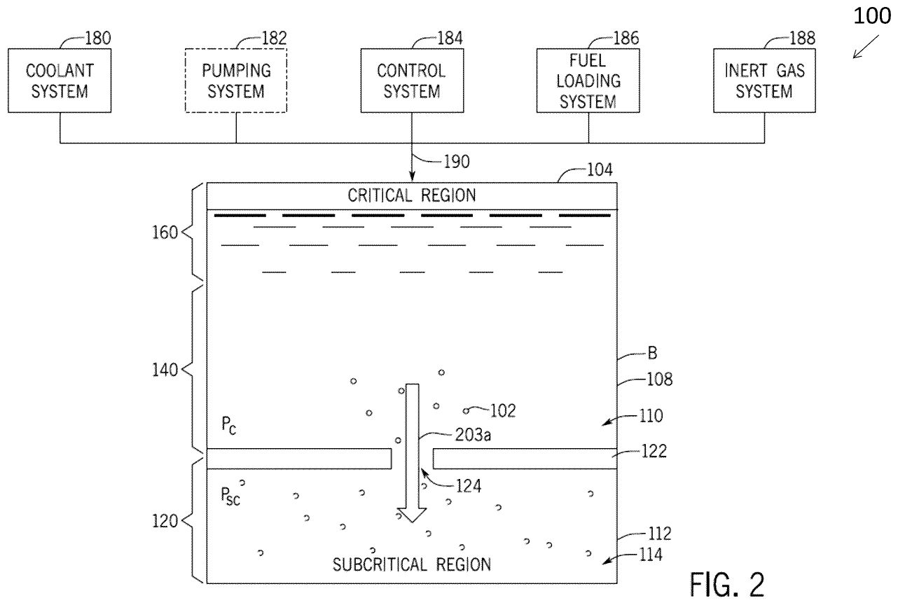

Turning to FIG. 2, a schematic representation of the integral MSR 100 is shown in a second configuration B. In the second configuration B, the fuel salt 102 may be passively transferred to the subcritical region 112. For example, the fuel salt 102 may be caused to progress along a flow 203a that proceeds from the critical region 108 to the subcritical region 112. Transferring of the fuel salt 102 to the subcritical region 112 in this manner may allow the fuel salt 102 to be physically separated from the reactor core and/or other components of the critical region 108. Accordingly, the fuel salt 102 may be held away from such components so that the fuel salt 102 may cease being heated or otherwise be removed from certain fission reactions of the critical region 108.

To facilitate the foregoing, the inert gas system 188 may control the pressures P_{c}, P_{sc}. For example, the inert gas system 188 may cause the pressure P_{sc} to be less than or equal to the P_{c}. As such, the fuel salt passage 124 may become depressurized so that the pressure of the fuel salt passage 124 no longer mitigates or prevents the fuel salt 102 from flowing therethrough. Rather, on the depressurization of the fuel salt passage 124, the fuel salt 102 may gravitationally flow through the fuel salt passage 124 and into subcritical region 112. The integral MSR 100 may therefore be considered “walk-away” safe because the passive or default state or configuration is one in which the fuel salt 102 is held away from the critical region 108 so that the fuel salt 102 is not subject to excessive heating.

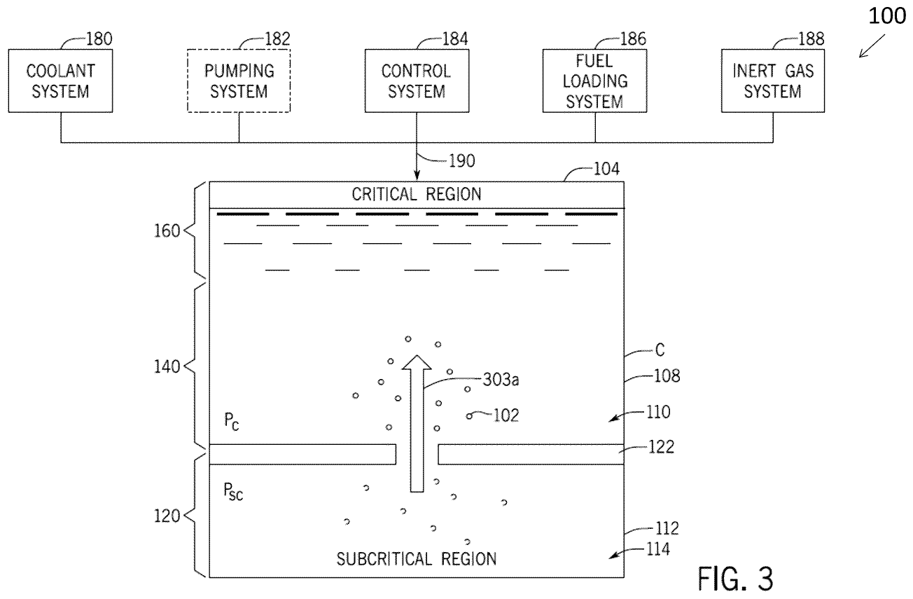

Turning to FIG. 3, a schematic representation of the integral MSR 100 is shown in a third configuration C. In the third configuration C, the fuel salt 102 may be actively transferred to the critical region 108. For example, the fuel salt 102 may be caused to progress along a flow 303a that proceeds from the subcritical region 112 to the critical region 108. Transferring of the fuel salt 102 to the critical region 108 in this manner may allow the fuel salt 102 held in the subcritical geometry to be used in conjunction with fission reactions for the generation of heat in the critical region 108. To facilitate the foregoing, the inert gas system 188 may control the pressures Pc, Psc. For example, the inert gas system 188 may cause the pressure Psc to be greater than the pressure Pc. As such, the fuel salt 102 held in the subcritical volume 14 may be encouraged to travel through the fuel salt passage 124 and into the critical volume 110. The inert gas system 188 may further operate to maintain the pressure Psc as being greater than the pressure Pc so as to maintain the fuel salt passage 124 in a pressurized state such that the fuel salt 102 is mitigated or prevented from entering the subcritical region 112, as described in relation to FIG. 1. Because the act of transferring the fuel salt 102 from the subcritical region 112 to the critical region 108 is the result of active pressurization, upon the loss of such pressure (e.g., due to emergency event, including a loss of power), the fuel salt 102 will be encouraged to passively drain or dump back to the subcritical region 112, for example, using the fuel salt passage 124.

It will be appreciated that the integral MSRs described herein maybe be implemented with a variety of components, systems, and subassemblies. To provide context for the improved control blade assemblies of FIGS. 6-9, FIGS. 4 and 5 illustrate an integral MSR with control rods as known in the prior art. FIG. 4 depicts components of an integral MSR 400. The integral MSR 400 may include an integrally constructed vessel 404, a critical region 408, a critical volume 410, a subcritical region 412, a subcritical volume 414, a drain tank section 420, an internal barrier 422, a fuel salt passage 424, a reactor section 440, and a heat exchange section 460, redundant explanation of which is omitted here for clarity.

The integral MSR 400 shown in FIGS. 4 and 5 includes an outer container 480 that may be used to define a containment space about the vessel 404. For example, the outer container 480 may be configured to fully receive the vessel 404 and define a thermal barrier between the vessel 404 and an external environment. The vessel 404 may therefore be arranged in the outer container 480 in order to define an annular space 482 between the vessel 404 and the outer container 480. The annular space 482 may be held at a pressure Pᵥ, which may be a vacuum pressure. In other cases, Pᵥ may be adapted based on the thermal requirements of the integral MSR 400. Additionally or alternatively, the annular space 482 may be configured to receive gas that may be adapted for emergency cooling of the vessel 404, among other uses.

The integral MSR 400 may include a drain tank section 420. The drain tank section 420 may be substantially analogous to the drain tank section 120 described in relation to FIGS. 1-3 and therefore may be configured to hold a volume of fuel salt away from a reactor core and/or other components that occupy the critical region 408 of the integral MSR 400. For example, the drain tank section 420 may be configured to hold the fuel salt in the subcritical volume 414, which may generally be defined collectively by the internal barrier 422, drain tank walls 426, and floors 428. The internal barrier 422 may be a structural component that establishes a physical barrier and physical separation between fuel salt held in the critical volume 410 and fuel salt held in the subcritical volume 414. In this regard, the internal barrier 422 may have a sufficient strength and rigidity in order to support a weight of the fuel salt within the critical region 408 without undue deformation or encroachment of the internal barrier 422 into or toward the subcritical volume 414.

The internal barrier 422 may be adapted to permit the passage of fuel salt between the critical volume 410 and the subcritical volume 414 only via the fuel salt passage 424 defined through the internal barrier 422. In order to permit the transfer of fuel salt between the critical volume 410 and the subcritical volume 414, the drain tank section 420 may further include a transfer pipe 430. The transfer pipe 430 may extend from the fuel salt passage 422 toward the floors 428 of the drain tank section 420. As shown in FIG. 4, the floors 428 may be sloped to encourage fuel salt toward the transfer pipe 430. For example, an end of the transfer pipe 430 may have a mouth 432 that is disposed adjacent to the floors 428 of the drain tank section 420. In this regard, and as described in greater detail herein, fuel salt can be transferred from the subcritical volume 414 to the critical volume 410 until said fuel salt reaches an elevational level of the mouth 432 in the subcritical volume 414.

The integral MSR 400 may include the reactor section 440. The reactor section 440 may be substantially analogous to the reactor section 140 described in relation to FIGS. 1-3 and therefore may be configured to receive a volume of fuel salt from the drain tank section 220 and cause fission reactions that heat the fuel salt. For example, the reactor section 440 may generally include a reactor core 442 formed at least partially from a moderator material 444, such as a graphite material. The reactor core 442 may cause or otherwise facilitate the undergoing fission reactions in the critical region 408. Accordingly, the reactor core 442 may be constructed in a manner to receive the fuel salt and to cause the fuel salt to be heated therein. In this regard, the reactor core 442 is shown in FIG. 5 as having a fuel salt passage 446 that extends generally from a core bottom side 448a to a core top side 448b. As described herein, the fuel salt may be encouraged to travel through the fuel salt passage 446, and in so doing, the fuel salt may be heated by fission reactions. The reactor core 442 is further shown in FIG. 5 as having peripheral sides 449. The peripheral sides 449 may generally be transverse sides to the core bottom and top sides 448a, 448b. The peripheral sides 449 may be arranged in order to define a core section passage 450 between the reactor core 442 and the vessel 404. As described herein, the fuel salt may be encouraged to travel through the core section passage 450 upon removal of heat from the fuel salt at the heat exchange section 460, and for subsequent recirculation into the core 442.

The reactor core 442 may further includes various components to facilitate various other functions of the integral MSR 400. For example, the reactor core 442 is further shown in FIG. 5 as including a control rod accommodating portion 451 in accordance with the prior art approach to control rods. The control rod accommodating portion 451 may be a void or cavity that extends into the moderator material 444 and that is operable to receive one or more control rod structures and/or other structures that are operable to control reactivity of the core 442 (including components that may be used to slow or stop a nuclear reaction in core 442). Further, the reactor core 442 is shown in FIG. 5 as including a fuel loading accommodating portion 452. The fuel loading accommodating portion 452 may be a lumen, duct, or other through passage that allows for one or more fuel loading pipes to extend through the core 442 in order to reach the subcritical volume 414. In this regard, and as described herein, the subcritical volume 414 may be loaded with a fuel salt from a topmost region of the integral MSR 400, passed through the core 442, and stored in the drain tank section 420 below. The reactor core 442 is further shown in FIG. 6 as including an inert gas line accommodating portion 453. The inert gas line accommodating portion 453 may be a lumen, duct, or other through passage that allows for one or more inert lines or pipes to extend through the core 442 in order to reach the subcritical volume 414. In this regard, and as described herein the subcritical volume 414 may be pressurized with inert gas from a topmost region of the integral MSR 400.

The integral MSR 400 may include the heat exchange section 460. The heat exchange section 460 may be substantially analogous to the heat exchange section 160 described in relation to FIGS. 1-3 and therefore may be configured to receive a flow of the heated fuel salt from the reactor section 440 and remove heat therefrom. For example, the heat exchange section 460 may have one or more heat exchangers 462. The heat exchanger 462 may generally take any of variety of forms in order to transfer heat from fuel salt of the critical volume 410 to a coolant salt or other medium that is held by the heat exchanger 462. In some examples, the heat exchanger 462 may include a shell having passages that lead into the heat exchanger 462. Fuel salt (such as that which has been heated from one or more fission reactions) may be routed to the heat exchanger 462 where heat is transferred to a coolant pipe having a coolant salt disposed therein.

The integral MSR 400 may further include a variety of other components to support the operation of the reactor. The integral MSR 400 may include a control system that controls the reactivity of the reactor. Specifically, the control system may include one or more control rods, such as control rod 484. The control rod 484 may be a calibrated piece of material that is selectively lowered and raised into the reactor 442 in order to reduce or stop a nuclear reaction occurring therein. The control system may includes gears, levers, and other mechanisms that allow the control rod 484 to be selectively raised and lowered in the reactor vessel 404.

As further shown in FIG. 4, the integral MSR 400 may include a fuel load line 486. The fuel load line 486 may be a pipe or conduit that is operable to carry a fuel salt from an environment exterior to the integral MSR 400 to the subcritical volume 414. For example, the fuel load line 486 may including a loading end 486a that is arranged outside of the outer container 480 and that is adaptable to receive a load of fuel salt therein. The fuel load line 486 may further include a dispensing end 486b that is arranged within the subcritical volume 414. In this regard, the fuel salt received at the loading end 486a may be routed to through the fuel load line 486 and to the subcritical volume 414 for dispensing thereto via the loading end 486a.

As further shown in FIG. 4, the integral MSR 400 may include a pair of inert gas lines, including a subcritical gas line 487 and a critical region gas line 488. Each of the gas lines 487, 488 may be operable to control a pressure in the vessel 404. For example, the subcritical gas line 487 may have a loading end 487a that is arranged outside of the outer container 480 and operable to receive a flow of inert gas for routing to a dispensing end 487b that is arranged within the subcritical volume 414. Accordingly, a flow of inert gas can be controlled in order to control a pressure P_{dt} of the subcritical volume 414, thereby controlling a pressure in the drain tank section 420. Further, the critical gas line 488 may have a loading end 488a that is arranged outside of the outer container 480 and operable to receive a flow of inert gas for routing to a dispensing end 488b that is arranged with the critical volume 410. Accordingly, a flow of inert gas can be controlled in order to control a pressure Pₕₜ of the heat exchange section 460 of the critical volume 410, and to control a pressure Pᵣ of the reactor section 440 of the critical volume 410.

The example integral MSR 400 of FIGS. 4 and 5 does not include a pumping mechanism. Therefore, the integral MSR 400 may use convection to induce a continuous circulation of the fuel salt between the reactor section 440 and the heat exchange section 460. In other cases, a pump may be used to support such circulation.

Referring now to FIGS. 6-10, example embodiments of the improved control blade assembly will be described in accordance with this disclosure. The example embodiments of FIGS. 6-10 are described in the context of an integral MSR similar to the MSR 100 generally described previously in connection with FIGS. 1-3. Accordingly, where components or features of the integral MSR of FIGS. 1-3 are similar or analogous to components or features of the integral MSR of FIG. 6, the descriptions of those previous components and features are applicable to the example of FIG. 6. Moreover, with respect to the integral MSR 400 of FIGS. 4 and 5 comprising the prior art control system and control rods, where components or features of the integral MSR of FIGS. 4 and 5 are similar or analogous to components of features of the integral MSR of FIG. 6, the descriptions of those previous components and features are applicable to the example of FIG. 6.

FIG. 6 depicts integral MSR 600 comprising an outer container 680 in which components of the integral MSR 600 are disposed. Within the outer container 680 is a vessel 604 with an annular space 682 between the outer container 680 and the vessel 604. Similar to the previous descriptions associated with FIGS. 1-3, the vessel 604 generally can be viewed as comprising a drain tank section 620, a reactor section 640, and a heat exchanger section 660. Fuel salt flows upward from the drain tank section 620 into the reactor section 640 where fission reactions take place in a reactor core 642. As the fission reactions take place, the fuel salt is heated and flows upward to the heat exchange section where heat from the fuel salt is transferred to one or more heat exchangers 662a and 662b for generating power. After transferring heat at the heat exchangers 662a and 662b, the fuel salt flows down toward the bottom of the reactor where the cycle is repeated. The broken arrows in FIG. 6 generally illustrate the direction of flow of the fuel salt within the vessel 604. While not required, example integral MSR 600 also includes a barrel 670. The barrel 670 is a cylindrical structure located between the reactor core 642 and the vessel 604. The presence of the barrel 670 can facilitate the cyclic flow of the fuel salt within the vessel 604 as illustrated by the broken arrows.

Integral MSR 600 also comprises a control blade assembly 630. The control blade assembly 630 may be operated by the MSR's control system, similar to the control system 184 described in connection with FIGS. 1-3. As described previously, the control system can modulate the reactivity of the reactor. In contrast to the control rods of the prior art as illustrated in FIGS. 4 and 5, the control system of MSR 600 actuates the control blade assembly 630 to move one or more control blades horizontally into or out of the reactor core 642. While only one control blade is illustrated in FIG. 6, typically a reactor would have multiple control blades located at different positions around the reactor core.

In the example of FIG. 6, the control blade assembly 630 comprises a driver 631 and an actuator 632 that move vertically in a direction generally parallel with the vertical axis 601 of the MSR reactor 600. The driver 631 may be activated by signals from the control system. The driver 631 may include a motor and piston or other similar components that achieve the vertical motion of the actuator 632. Preferably, the driver 631 is completely contained within the walls of the outer container 680.

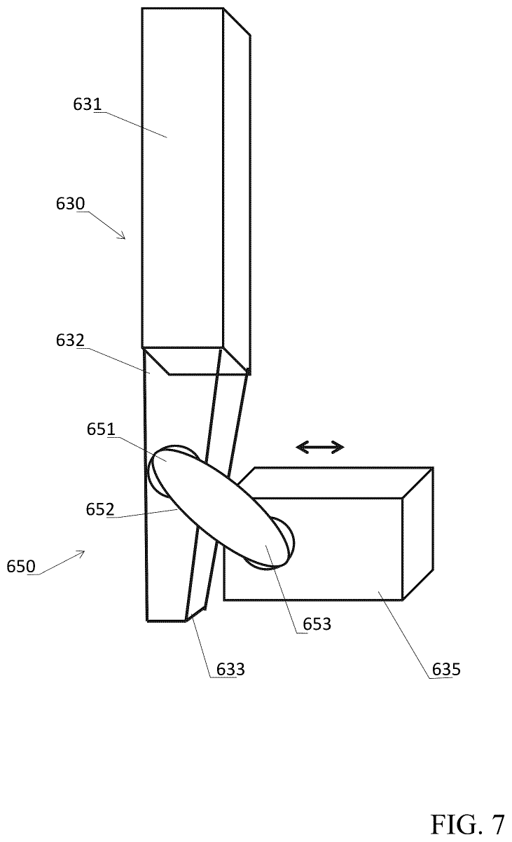

The actuator 632 is configured so that as the driver 631 causes it to move vertically (up or down), the actuator 632 causes a control blade 635 to move horizontally (inward toward the reactor core or outward away from the reactor core). This translation of vertical motion to horizontal motion can be achieved by one of a variety of mechanisms as will be described further below in connection with the examples of FIGS. 7-9. In general, the actuator 632 and the control blade 635 are joined by a coupling 650. The coupling 650 may be located along an inward surface 633 of the actuator 632. As illustrated in the example of FIG. 6, the inward surface 633 of the actuator 632 may be oblique with respect to the vertical axis 601. In other words, the horizontal cross-section of the actuator 632 is wider at its upper portion near the driver 631 and is narrower at its lower portion away from the driver 631. The oblique shape of the inward surface 633 causes the actuator 632 to move the control blade 635 inward toward the reactor core 642 when the actuator 632 moves in a downward direction. Conversely, the oblique shape of the inward surface 633 causes the actuator 632 to move the control blade 635 outward away from the reactor core 642 when the actuator moves in an upward direction. The horizontal motion of the control blade 635 is illustrated by the horizontal bidirectional arrow in FIG. 6.

As also illustrated in FIG. 6, the control blade 635 may be disposed within a container 634. The container 634 holds the control blade in the appropriate position within the reactor. The container 634 may be secured in position by a weld or other attachment means that secures the container 634 to an inner surface of the side wall of the vessel 604. The container 634 includes an upper aperture on its upper side and a lower aperture on its lower side. The upper aperture and the lower aperture allow the actuator 632 to move vertically up and down through the container 634. Additionally, the container 634 has a radial aperture on its side facing toward the reactor core 642. The radial aperture in the container 634 allows the control blade 635 to extend horizontally through the radial aperture and out of the container 634 toward the reactor core 642 and to retract horizontally through the radial aperture and into the container 634 away from the reactor core 642.

Accordingly, when there is a need to slow the reactivity of the MSR reactor 600, the control system can activate the driver 631 to move the actuator 632 downward vertically through the upper aperture and lower aperture of the container 634. The oblique inward surface 633 of the actuator 632 and the coupling 650 to the control blade 635 cause the control blade 635 to extend horizontally out of the container 634 and toward the reactor core 642. The absorbing material of the control blade 635 will cause the fission reactions to slow. Conversely, when there is a need to increase the reactivity of the MSR reactor 600, the control system can activate the driver 631 to move the actuator 632 upward vertically through the upper aperture and the lower aperture of the container 634. The oblique inward surface 633 of the actuator 632 and the coupling 650 to the control blade 635 cause the control blade 635 to retract horizontally into the container 634 and away the reactor core 642. Removing the absorbing material of the control blade 635 from the reactor core 642 will increase the reactivity of the reactor.

The combination of the vertical and horizontal motion of the control blade assembly 630 provides an improvement over prior art control rods in that less head space above the MSR 600 is required. In other words, the horizontal motion of the control blades reduces the total amount of vertical motion that would typically be required with conventional control rods that move exclusively in the vertical direction. The arrangement of the control blade assembly also allows for moving the control blade 635 farther away from the reactor core 642 as compared to a conventional control rod, which improves the efficiency of the reactor.

Turning to FIG. 7, one example implementation of the control blade assembly 630 is illustrated. FIG. 7 shows the driver 631, actuator 632, and control blade 635 components of the control blade assembly 630. Additionally, the container has been omitted in FIG. 7 to illustrate the details of one type of coupling 650. The example coupling 650 of FIG. 7 includes an actuator pin 651, a control blade pin 653, and a linkage 652 that connects the actuator pin 651 and the control blade pin 653. The combination of the actuator pin 651, the control blade pin 653, the linkage 652, and the oblique inward surface 633 of the actuator 632 can be used to move the control blade 635 horizontally. As the driver 631 moves the actuator 632 downward, the combination of the linkage 652 and the wider portion of the actuator 632 along the oblique inward surface 633 push the control blade 635 horizontally away from the actuator 632 and toward the reactor core 642. Conversely, as the driver 631 moves the actuator 632 upward, the combination of the linkage 652 and the narrower portion of the actuator along the oblique inward surface 633 pull the control blade horizontally toward the actuator 632 and away from the reactor core 642. As such the example coupling 650 illustrated in FIG. 7 can be used to move the control blade 635 and modulate the reactor.

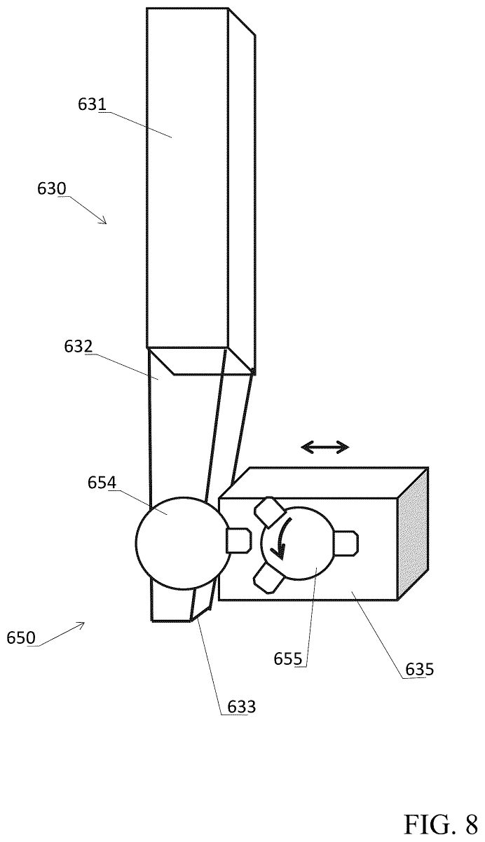

Turning to FIG. 8, another example implementation of the control blade assembly 630 is illustrated. FIG. 8 shows the driver 631, actuator 632, and control blade 635 components of the control blade assembly 630. Additionally, the container has been omitted in FIG. 8 to illustrate the details of one type of coupling 650. The example coupling 650 of FIG. 8 includes an actuator pin 654 and a gear 655 on the control blade 635. The combination of the actuator pin 654, the gear 655, and the oblique inward surface 633 of the actuator 632 can be used to move the control blade 635 horizontally. Specifically, as the actuator 632 moves vertically the actuator pin 654 engages the gear 655 causing the gear 655 to rotate. The rotating gear 655 engages threads within the control blade 635 causing the control blade 635 to move horizontally. For example, as the driver 631 moves the actuator 632 downward, the combination of the actuator pin 654, the gear 655, and the wider portion of the actuator 632 along the oblique inward surface 633 push the control blade 635 horizontally away from the actuator 632 and toward the reactor core 642. Conversely, as the driver 631 moves the actuator 632 upward, the combination of the actuator pin 654, the gear 655, and the narrower portion of the actuator 632 along the oblique inward surface 633 pull the control blade horizontally toward the actuator 632 and away from the reactor core 642. As such the example coupling 650 illustrated in FIG. 8 can be used to move the control blade 635 and modulate the reactor.

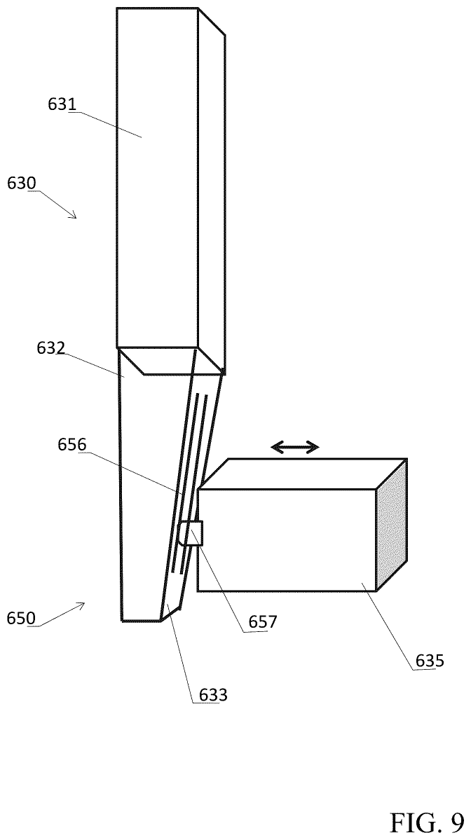

Turning to FIG. 9, another example implementation of the control blade assembly 630 is illustrated. FIG. 9 shows the driver 631, actuator 632, and control blade 635 components of the control blade assembly 630. Additionally, the container has been omitted in FIG. 9 to illustrate the details of one type of coupling 650. The example coupling 650 of FIG. 9 includes an actuator slot 656 and a control blade slider 657 on the control blade 635. The control blade slider 657 can be secured within the actuator slot 656 so that it remains in the actuator slot 656 as the actuator moves up or down. The combination of the actuator slot 656, the control blade slider 657, and the oblique inward surface 633 of the actuator 632 can be used to move the control blade 635 horizontally. As the driver 631 moves the actuator 632 downward, the combination of the actuator slot 656, the control blade slider 657, and the wider portion of the actuator 632 along the oblique inward surface 633 push the control blade 635 horizontally away from the actuator 632 and toward the reactor core 642. Conversely, as the driver 631 moves the actuator 632 upward, the combination of the actuator slot 656, the control blade slider 657, and the narrower portion of the actuator along the oblique inward surface 633 pull the control blade horizontally toward the actuator 632 and away from the reactor core 642. As such the example coupling 650 illustrated in FIG. 9 can be used to move the control blade 635 and modulate the reactor.

The couplings illustrated in FIGS. 7, 8, and 9 are non-limiting examples. In alternate embodiments the coupling 650 can be implemented using other components or arrangements.

Turning to FIG. 10, an example method 700 is provided for operating an MSR using the improved control blade assemblies of the present disclosure. As described previously, an MSR controls the flow of fuel salt to and from the reactor core in order to generate heat that is used to provide power. As described in connection with FIGS. 1-3, the fuel salt first may be loaded into a subcritical region of the reactor and then circulated into a critical region of the reactor. Referring to operation 705 of method 700, as the fission reactions take place and generate heat, the MSR circulates fuel salt between the reactor section and the heat exchange section of the MSR. The fuel salt that has been heated by the fission reactions transfers heat to the heat exchangers and such heat is used to generate power.

When it is necessary to adjust the fission reactions in the reactor core, the MSR's control system can operate a control blade assembly such as one of the control blade assemblies described herein. In operation 710, the control system may activate a driver of the control blade assembly causing an actuator of the control blade assembly to move vertically. In connection with activating the driver, the control system may determine whether to speed up or slow down the fission reactions occurring in the reactor core as illustrated by decision operation 715.

If the control system determines a need to speed up the fission reactions, the control system can operate the control blade assembly to move the control blade horizontally away from reactor core and toward the wall of the reactor's vessel. Specifically, as illustrated by operation 725, the activated driver moves the actuator vertically upward causing the coupling to retract the control blade so that the control blade moves horizontally away from the reactor core. Moving the absorbing material of the control blade away from the reactor core will cause the fission reactions to speed up.

Alternatively, if the control system determines a need to slow the fission reactions, the control system can operate the control blade assembly to move the control blade horizontally toward and into the reactor core. Specifically, as illustrated by operation 720, the activated driver moves the actuator vertically downward causing the coupling to move the control blade so that the control blade moves horizontally toward the reactor core. Moving the absorbing material of the control blade into the reactor core will cause greater absorption of neutrons and cause the fission reactions to slow.

The arrangement and operation of the control blade assemblies described herein provide improvements for molten salt nuclear reactors. As illustrated by the foregoing examples, the horizontal movement of the control blade reduces the amount of vertical movement that would typically be required by a convention control system with conventional control rods that only move vertically. By reducing the amount of required vertical movement, the disclosed control blade assemblies reduce the amount of required head space above the reactor, thereby freeing up the head space for other reactor systems. Additionally, the horizontal movement of the control blades allows for more accurate control of the positions of the control blades relative to the reactor core, thereby providing more efficient operation of the reactor.

Other examples and implementations are within the scope of the disclosure and appended claims. For example, features implementing functions may also be physically located at various positions, including being distributed such that portions of functions are implemented at different physical locations. The foregoing description, for purposes of explanation, uses specific nomenclature to provide a thorough understanding of the described examples. However, it will be apparent to one skilled in the art that the specific details are not required in order to practice the described examples. Thus, the foregoing descriptions of the specific examples described herein are presented for purposes of illustration and description. They are not targeted to be exhaustive or to limit the examples to the precise forms disclosed. It will be apparent to one of ordinary skill in the art that many modifications and variations are possible in view of the above teachings.

What is claimed is:

1. A molten salt nuclear reactor comprising
a vessel;
a reactor section disposed within the vessel, the reactor section configured to receive a volume of fuel salt and heat the fuel salt through fission reactions; and
a heat exchange section configured to receive a flow of the fuel salt from the reactor section after heating and to remove heat therefrom; and
a control blade assembly disposed within the vessel, the control blade assembly comprising a control blade joined by a coupling to a drive rod, wherein motion of the drive rod causes the control blade to move horizontally within the vessel.

2. The molten salt nuclear reactor of claim 1, wherein the drive rod is configured to move vertically within the vessel.

3. The molten salt nuclear reactor of claim 1, wherein responsive to the drive rod moving downward in the vessel, the control blade moves into the reactor section.

4. The molten salt nuclear reactor of claim 1, wherein responsive to the drive rod moving upward in the vessel, the control blade moves away from the reactor section.

5. The molten salt nuclear reactor of claim 1, wherein an inward surface of the drive rod is oblique to a vertical axis of the vessel, wherein the inward surface of the rod is coupled to the control blade, and wherein vertical movement of the inward surface of the drive rod causes horizontal movement of the control blade.

6. The molten salt nuclear reactor of claim 1, wherein the control blade comprises boron carbide.

7. The molten salt nuclear reactor of claim 6, wherein the boron carbide is enclosed in a stainless steel cladding.

8. The molten salt nuclear reactor of claim 1, wherein the control blade assembly further comprises a container arranged to surround a portion of the control blade.

9. The molten salt nuclear reactor of claim 8, wherein the molten salt nuclear reactor is an integral molten salt nuclear reactor, and wherein the container is welded to an inner wall of the vessel.

10. The molten salt nuclear reactor of claim 8, wherein the container comprises: a top aperture through which the drive rod moves vertically, and a side aperture through which the control blade moves horizontally.

11. The molten salt nuclear reactor of claim 1, wherein the coupling allows the drive rod to slide vertically relative to the control blade.

12. The molten salt nuclear reactor of claim 1, wherein the coupling comprises a slider that slides within a slot.

13. The molten salt nuclear reactor of claim 1, wherein the coupling comprises a linkage connecting the drive rod and the control blade.

14. The molten salt nuclear reactor of claim 1, further comprising a barrel disposed between the reactor section and the vessel.

15. The molten salt nuclear reactor of claim 14, wherein the control blade moves horizontally through the barrel.

16. The molten salt nuclear reactor of claim 1, wherein the molten salt nuclear reactor is an integral molten salt nuclear reactor, wherein the control blade assembly further comprises a container that surrounds a portion of the control blade, and wherein the container is welded to an inner wall of the vessel.

17. The molten salt nuclear reactor of claim 16, wherein the container comprises: a top aperture through which the drive rod moves vertically, and a side aperture through which the control blade moves horizontally.

18. A method of operating a molten salt nuclear reactor comprising:
circulating a fuel salt from a reactor section to a heat exchange section of the molten salt nuclear reactor, wherein the circulating includes removing heat from the fuel salt;
and activating a control blade assembly disposed within a vessel of the molten salt nuclear reactor, the control blade assembly comprising a control blade joined by a coupling to a drive rod, wherein the activating comprises moving the drive rod in a vertical direction causing the control blade to move in a horizontal direction.

19. The method of claim 18, wherein activating the control blade comprises moving the drive rod in a downward direction within the vessel causing the control blade to move in a horizontal direction into the reactor core.

20. The method of claim 18, wherein activating the control blade comprises moving the drive rod in an upward direction within the vessel causing the control blade to move in a horizontal direction out of the reactor core
